(19) United States
(12) Patent Application Publication
(10) Pub. No.: US 2006/0053044 A1
(43) Pub. Date: Mar. 9, 2006

(54) Dynamic scheduling tool for office appointments management

(76) Inventors: Joseph C. Kurian, North York (CA); William W. Melek, Toronto (CA)

Correspondence Address: HARNESS, DICKEY, & PIERCE, P.L.C, 7700 BONHOMME, STE 400, ST. LOUIS, MO, 63105, US

(21) Appl. No.: 11/082,681

(22) Filed: Mar. 17, 2005

(30) Foreign Application Priority Data
Sep. 7, 2004 (CA) 2,481,060

(51) Int. Cl. G06F 15/02

(52) U.S. Cl. 705/9

(57) ABSTRACT

Method and system for dynamically scheduling and managing appointments of professional services using artificial intelligence. The appointment schedule can be shifted, updated and rearranged in real time based on a plurality of inputs.

### CROSS-REFERENCE TO RELATED APPLICATION

The present application claims priority to Canadian application number 2,481,060, titled “Dynamic Scheduling Tool for Office Appointments Management” filed Sep. 7, 2004.

### FIELD OF INVENTION

The present invention relates to methods and systems for dynamic resource allocation. In particular, the present invention relates methods and systems for scheduling optimization of appointments using artificial intelligence.

### BACKGROUND OF THE INVENTION

Computer programs for appointment scheduling have been known in the art. Users of such programs have been able to make their own respective schedules. In a group practice such as a medical office or in a clinic with several professionals, appointments are usually scheduled by office personnel, in response to patients' or professionals' requests, for a large number of professionals and resources.

However, as a working day progresses, circumstances may occur that require modifications of the schedules in real time. For example, patients may call in for emergency appointments or cancellation; unanticipated delays may occur; medical history of a patient may indicate that he needs more or less than the allocated standard time slot. At the present time it is very difficult, if not impossible, to schedule appointments with a doctor, at a short notice. Those circumstances are known to result in increased patient anxiety, in increased risk of aggravating an existing medical condition requiring immediate medical attention and in increased cost of care when such callers use more costly services such as hospital emergency rooms when their need for medical advice cannot be adequately satisfied.

U.S. Pat. No. 5,970,466 describes a graphical computer system and method for appointment scheduling. Appointments are scheduled for an office or business by displaying screen displays on a computer monitor, including a day view screen display with a plurality of thermometer-style schedules opposite a daily appointment file. In a “day view” schedules are arranged by selecting a group from a group list. The appointments can be predetermined as to type and duration, and a scheduler can refer to a list of such pre-configured appointments in scheduling patients. Various types of color-coding arrangements and icons are provided for patient status.

U.S. Pat. No. 6,345,260 provides a system and method for scheduling appointments with a professional, such as a doctor, dentist, veterinarian, or the like, or a professional service, such as a medical testing facility and the like, even when the office of the professional or professional service is closed. The system and method relate to an asynchronous network based appointment scheduling interface for making appointments, and permit off-line review and posting, as well as central scheduling.

Those techniques, exemplify a static approach of the existing appointment organization tools, based on an expert system for manipulating knowledge. The basic concept underlying an expert system is that a collection of specific IF-THEN rules are used to manipulate input data to derive a solution. These rules dictate how the data associated with a particular problem should be manipulated are developed. These rules are eventually programmed into the machine so that, given a set of input data, the formulated rules can be applied to the data to yield a solution. Expert systems are generally associated with deductive reasoning. In other words, to implement an expert system one must first have some previous information indicating how a problem should be solved or a model describing the problem's underlying process in terms of a set of rules. This approach is, however, not suitable for scheduling professional services such as medical services, which are associated by their very nature with event uncertainties such as emergencies and cancellations.

Artificial neural networks, on the other hand, are generally associated with inductive learning. An artificial neural network has generally processing nodes that receive input and produce an output in response to the input. The artificial neural network can be trained by providing it data representative of known problems and their known solutions, the artificial neural network thus learns from the set of known problems and solutions.

At the present time it is not possible to optimize appointments based on artificial intelligence and a plurality of real-time information, in an appointment scheduling computer program. In addition, it is desired to schedule various kinds of medical appointments by one or more staff for a group of professionals and/or for a group of facility and/or equipment resources, through artificial intelligence based on artificial neural network.

### SUMMARY OF THE INVENTION

It is an object of the invention to provide an improved dynamic scheduling tool for office appointments management.

According to one aspect of the present invention there is provided a method for scheduling a professional service using artificial intelligence, the method comprising the steps of: storing historical data; training a neural network using the historical data to learn a schedule allocation; receiving a current request for the professional service; generating one or more than one input signals based on the current request; applying the input signals to the neural network having the learned schedule allocation; reserving an appointment in a schedule; and outputting the appointment.

According to another aspect of the present invention there is provided an apparatus for scheduling a professional service using artificial intelligence, the apparatus comprising: a memory for storing historical data; a neural network having a plurality of nodes, each node connected to one or more than one neighboring nodes, said neural network trained by the historical data to modify the weights, said neural network being responsive to a plurality of input signals, including one or more than one input signals generated from a current request for the professional service; said neural network generates an appointment in a schedule; and means for displaying the schedule.

According to yet another aspect of the present invention there is provided a computer readable medium storing instructions or statements for use in the execution in a computer of a method for scheduling a professional service using artificial intelligence, the method comprising the steps of: storing historical data; training a neural network using the historical data to learn a schedule allocation; receiving a current request for the professional service; generating one or more than one input signals based on the current request; applying the input signals to the neural network having the learned schedule allocation; reserving an appointment in a schedule; and outputting the appointment.

According to yet another aspect of the present invention there is provided a computer program product comprising: a memory having microcontroller-readable code embedded therein for scheduling a professional service using artificial intelligence, comprising: code means training a neural network using the historical data to learn a schedule allocation; code means for receiving a current request for the professional service; code means for generating one or more than one input signals based on the current request; code means for applying the input signals to the neural network having the learned schedule allocation; code means for generating an appointment in a schedule; and code means for outputting the appointment.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is an schematic illustration of a neural network;

FIG. 2 illustrates a back propagation in a neural network;

FIG. 3 shows a display screen of a dynamic live scheduler in accordance with an embodiment of the present invention;

FIG. 4 shows a display screen of a dynamic live scheduler in accordance with an embodiment of the present invention with a background discontinuity;

FIG. 5 shows the steps of appointment booking based on resource availability;

FIG. 6 is a block diagram showing the artificial intelligence module in revising the appointment schedule;

FIG. 7 is a block diagram for allocating blocked time segments; and

FIG. 8 is a block diagram for rescheduling an appointment in accordance with a further embodiment of the present invention.

### DETAILED DESCRIPTION

The following description is a preferred embodiment.

As discussed before, traditional appointment scheduling systems rely on explicitly stated, blocked time segment with rules for different resource allocation. These rules are often implemented into the prediction system based on the history of data. However, data may have subtle and/or unknown relationships not adaptable to explicitly stated rules. In addition, events in professional services are inherently uncertain, data is often distorted, or incomplete, therefore, explicitly stated rules may fail.

On the other hand, computational systems known as artificial neural networks or simply neural networks allow patterns in data to be recognized and successive states to be predicted without the above limitations of traditional prediction systems. In a neural network model, simple nodes (or “neurons”) are connected together to form a network of nodes—hence the term “neural network”.

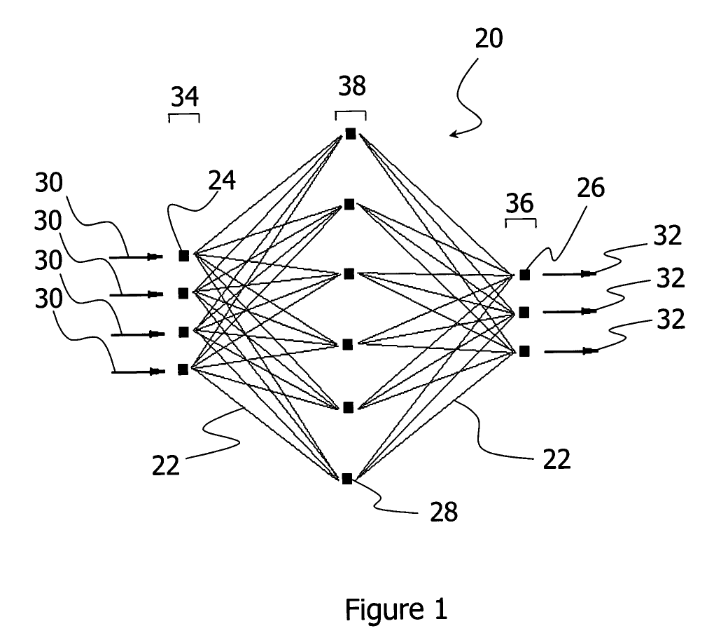

Referring to FIG. 1, a typical feedforward neural network (20) includes a set of input nodes (24), a set of output nodes (26), and a set of intermediate nodes (28). There are also connections (22) between the nodes. There are three layers in the neuron network in FIG. 1. There are four nodes in a first layer (34), three nodes in an output layer (36) and six nodes in an intermediate (hidden) layer (38). Input signals (30) are applied to input nodes (24) which, after processing, relay their results to other nodes (28). These nodes, in turn, process their input signals and pass along their results to still other nodes. The final output signal (32), in this example, is a combination of output from three nodes.

Lacking expert rules, the nodes of a neural network are assigned a predetermined initial weight. The neural network is then reconfigured by adjusting the weights to each node by training the neural network. Training a neural network by supervised learning involves inputting a known set of inputs, processing the inputs through the hidden layer, obtaining the resulting set of outputs from the neural network, comparing the resulting outputs with a known set of outputs corresponding to the known set of inputs, adjusting the weights of each node based on a comparison of the resulting and known outputs, and repeating the training until the neural network obtains weights which would generate the known outputs within a required degree of error. The neural network thereby learns to generate the known outputs from the known inputs, and then may be used for generating outputs from unknown inputs in use in the field.

One of the more popular techniques used for training feedforward neural networks is the back propagation.

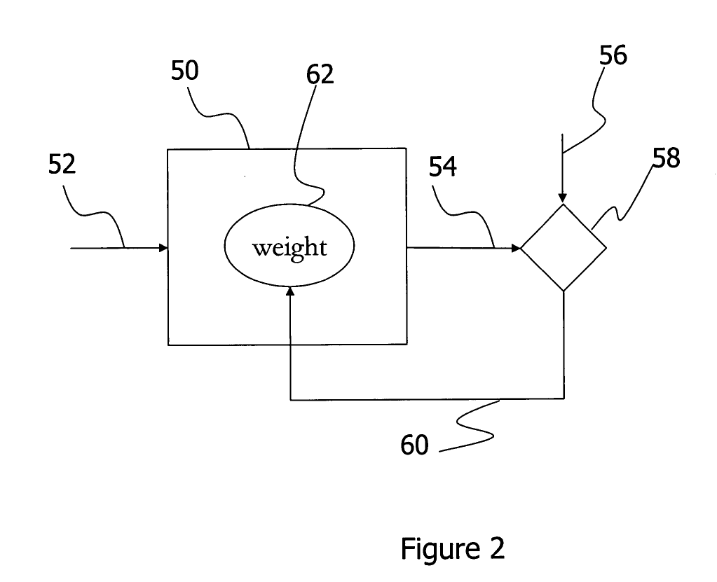

Referring to FIG. 2, a training sample (52) is presented to a neural network (50), the neural network's output (54) is compared to a required output (56) at an error generator (58) that calculates the error (60) in each output neuron from the error (60). The neural network (50) then calculates from the error (60), the actual output, and a scaling factor, i.e., how much lower or higher the weight (62) should be. As the name implies, the errors and the learning propagate backwards from the output nodes to the inner nodes.

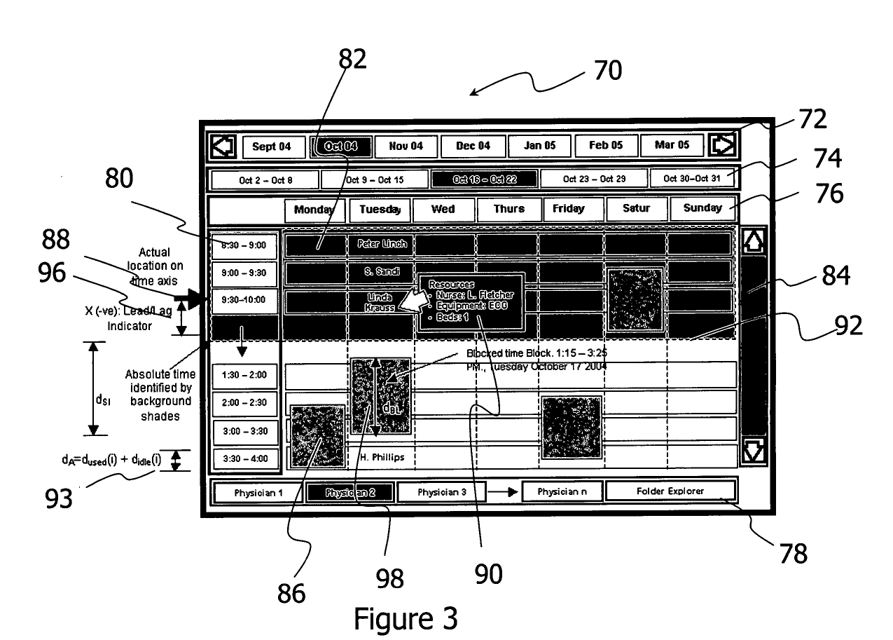

FIG. 3 is a screen display (70) of an embodiment of a dynamic scheduling tool for office appointment management.

At the top of the screen display there are three rows of multi-tab display for month and year (72), weeks within the month (74) and weekdays (76). At the bottom of the screen display there is another multi-tab display for selecting physicians (78). The screen display in FIG. 3 shows that the schedule of “Physician 2” for the week of Oct. 16 to 22, 2004 is selected.

At the left side of the screen there is a time axis illustrated by a column of boxes (80) with indicia of time along one side. To the right there is an appointment file (82) with rows or boxes corresponding to time slots for entry of appointment data. A vertical scroll bar (84) is provided for scrolling up and down the daily schedule. Once appointments have been entered, a color bar (86) extending for the duration of the appointment appears in the vertical graph. Rows in the appointment file (82) which represent time occupied by a long appointment are color-coded or shaded to signify unavailability. The actual location of progress on time axis is indicated by an arrow (88) in FIG. 3. At indicated in FIG. 3, at the actual location of progress, patient Linda Krauss is cared for by Physician 2, and requires the resource (90) of: a nurse, an ECG, and a bed. The display can have a multi-color scheme to track down the status of an appointment, and represent the status on the calendar by a different color that uniquely described the status. Examples of the status are: (i) waiting to see the physician, (ii) appointment in progress, and (iii) appointment completed.

Still referring to FIG. 3, a background discontinuity (92) in the scheduler screen in a time-scaled graph moves along the chronological axis at a rate proportional to the passage of time, such that its position tracks the current time. The background discontinuity shows the relation between current time, and the time associated with the appointments, i.e., chronological elements of the graph. The background discontinuity appears after any past appointment, but before any future appointment, thus showing which appointments are in the past, and which are in the future. In addition to relative time, real time or absolute time can also be shown. This requires that the chronological axis of the graph is made visible and given appropriate labels, so that times can be read from it. The absolute current time may then be read from the axis where it is intersected by the background discontinuity.

The status of the completed appointments versus the absolute time can be identified by the background discontinuity on the screen. In FIG. 3, lead-lag indicator (96) is an indicator of where the daily schedule status stands against the initial schedule defined a priori. The lead-lag indicator can refer to a lead, i.e., completion of the appointments is ahead of the initial planned schedule, or as illustrated in FIG. 3, a lag, i.e., completion of the appointments is behind the original schedule.

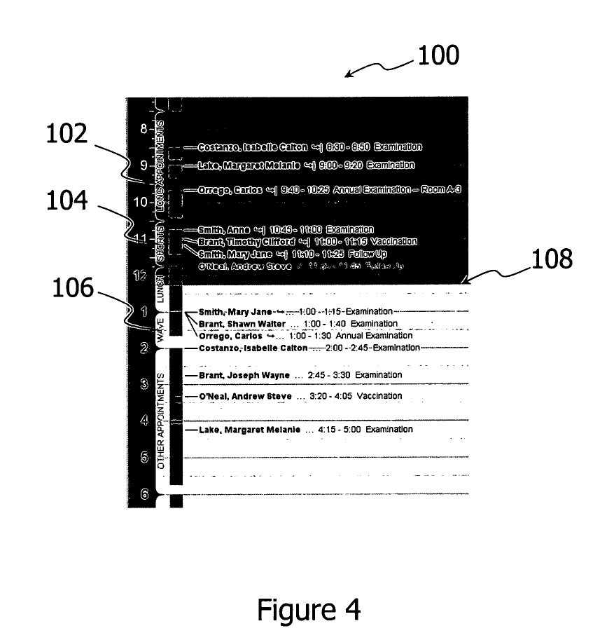

FIG. 4 is an example of a detailed view (100) of an appointment schedule for a professional. FIG. 4 shows long appointments (102), short appointments (104), and wave appointments (106), which are planed periods of multiple appointment to a single start time. A background discontinuity (108) progresses at a rate proportional to the passage of time, such that its position indicates the current time.

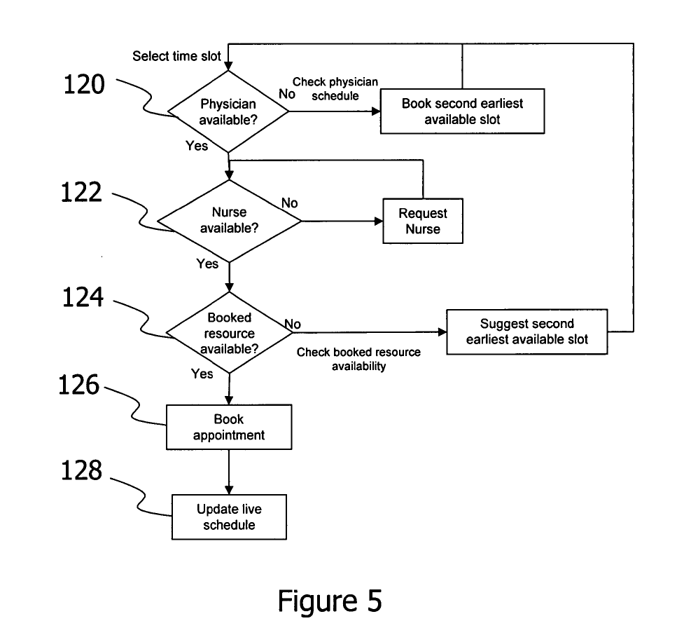

Referring to FIG. 5, the embodiment of the present invention can automatically find the first variable booking based on the resources allocated, and associate different types of resources such as nurse, physician, equipment, accordingly. For example, a patient who calls in to book for a 10 minutes appointment requires a doctor, room, and nurse. The scheduler checks for the first available appointment based on resource(s) availability and then assign the procedure to such vacant spot. At step 120, the scheduler checks to see whether a physician is available at a first available slot, if not, a second available time slot is selected. After ensuring the availability of the physician, the scheduler checks at step 122 the availability of a nurse, if a nurse is not available, a nurse is requested. At step 124, required resource for the appointment, for example, a examining room and other equipments, is checked, if the resource is not available, a second available time slot is again suggested, if the resource is available, then a time slot is booked (126) and the live schedule updated (128).

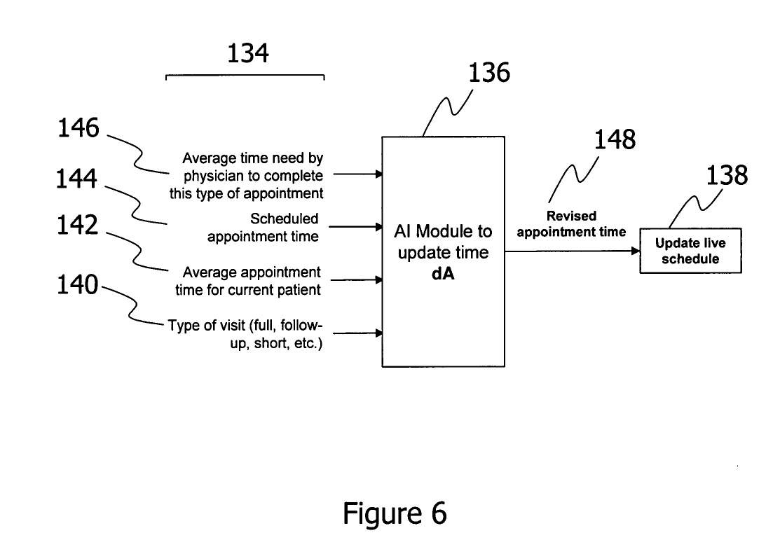

Therefore, as illustrated in FIG. 6, the embodiment of the present invention uses artificial intelligence in a neural network to automatically optimize the daily/weekly physician appointments by modifying the initial time allocation for every resource use in the available resources list to minimize the wait/idle time of the available resources. The invention uses artificial intelligence to modify the allocated time slot for a given procedure based on characteristics of the resource involved in the scheduling process. Characteristics (134) such as average time needed by physician to complete the similar type of appointments (146), scheduled appointment time (144), average appointment time for current patient (142), and the type of visit (14) are, for example, considered by an artificial intelligence module (136) to revise the appointment time and update the live schedule (138). Referring to FIGS. 1 and 6, it should be apparent to a person skilled in the art, that the above mentioned characteristics (134) are examples of the input signals (30) in FIG. 1, and the revised appointment time (148) is an example of the output signals (32) in FIG. 1.

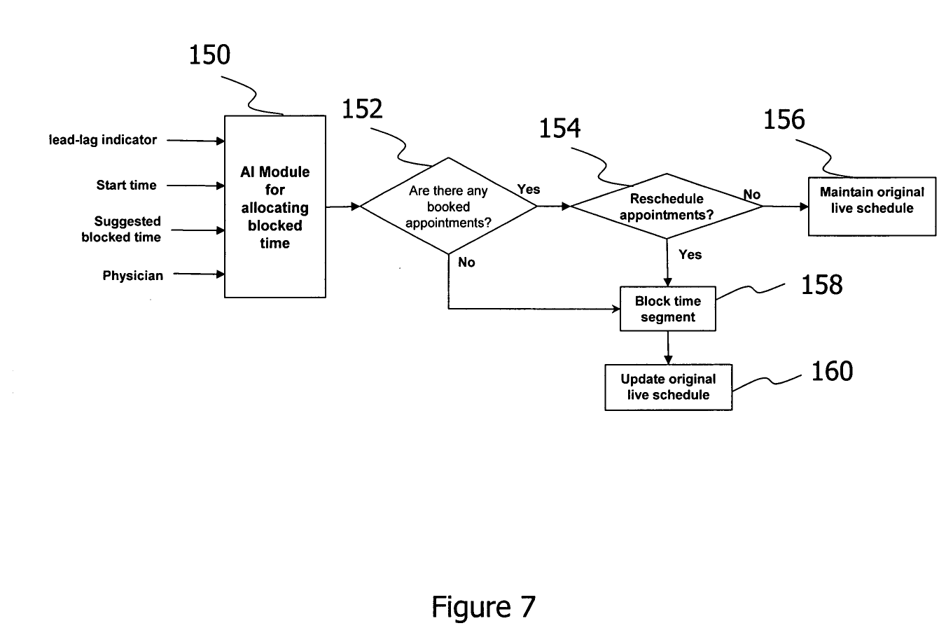

Referring to FIGS. 3 and 7, the invention can schedule a blocked appointment (98) by considering where the daily schedule status stands against the initial schedule defined a priori (variable X), the start time of the appointment, the duration of the blocked time, and the physician availability. After applying the artificial intelligence in the neural network (150) it decides whether there are any booked appointment (152). If there is one, the method as described in FIG. 5 is applied to determine the availability of the resources, and the appointments in a schedule may be needed to be rescheduled (154) and the live schedule updated (160). The present invention also has the capability of expanding or contracting a blocked time segment for optimization purposes. Similarly, the present invention can shift the existing dedicated blocked time segment to an earlier or later time.

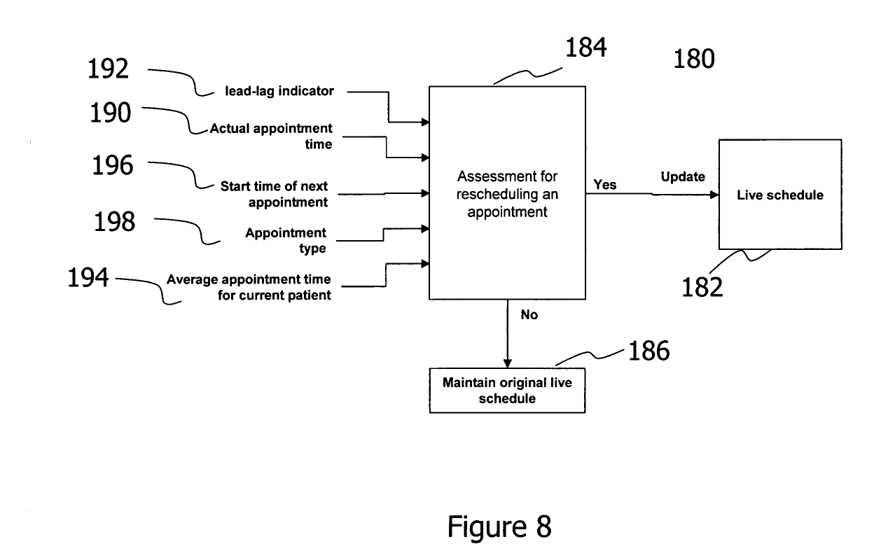

Referring to FIG. 8, the present invention can modify an initially assigned complete daily schedule a certain number of minutes if unanticipated delays occur such as the physician or nurse showing up late due to an earlier commitment, or if a patient shows up earlier than scheduled. For example, if a patient arrives early than the scheduled time, the neural network (184) of the present invention considers the actual appointment time (190), the current lead-lag indicator (192), the average appointment time for the patient (194), start time of next appointment (196), appointment type (198). Based on the assessment in the neural network (184) the live schedule is either updated (182) or maintained (186).

Referring to FIG. 3, the duration of the shift can be as small as a segment of the initial appointment allocation time denoted by d_{A} (93). The time of the appointment d_{A} can be 30 minutes for full visit, 20 minutes for follow-up visit, 10 minutes for short visit, or 5 minutes for inquiries. The duration d_{A} is often divided into time used in the appointment (d_{used}) and unused time (d_{idle}). In case the appointment extends beyond its initially allocated time, d_{idle} is negative. The idle time is incorporated after being rounded to the smallest time increment (5 minutes), i.e., it the time left over from one appointment is 8 minutes, it automatically maps to 10 minutes lead in the scheduler optimization algorithm. On the other hand, −2.8 minutes idle time means the appointment is extended 5 minutes past its scheduled completion time.

The embodiment of the present invention is capable of rearranging the sequence of the appointments if task scheduled for a later time in the day is ready to be executed and the schedule is idle at the moment because another task that is supposed to start is late and hence idle waiting time can be minimized. If the lead-lag indicator in FIG. 3 measures a lead, and the associated resource is currently idle then the rearrangement sequence takes place to accommodate early patient arrivals.

Referring to FIGS. 4 and 8, the embodiment of the present invention can shift (over a given daily time span of physician working hours) of dedicated blocked time segments to group them into a sequence of similar procedures (102, 104, 106) to optimize the overall daily or weekly schedule.

Similarly, the embodiment of the present invention can handle overbookings of a given time slot by reshuffling the initial schedule. This can be achieved in one of two ways: (a) eliminating the overbooking problem via completing empty slots resulting from unanticipated cancellations with one or more of the conflicting appointments, and/or (b) eliminating overbooking through stretching out the initial schedule by efficiently spreading the overbooked appointments and incorporating them in a modified version of the initial beginning-of-the-day schedule. Handling of overbooked appointments through options (a) or (b) can also be achieved through extending, or contracting the blocked time segments in the daily schedule.

The embodiment of the present invention can be implemented in digital electronic circuitry, or in computer hardware, firmware, software, or in combinations thereof. Apparatus of the invention can be implemented in a computer program product tangibly embodied in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor receives instructions and data from a read-only memory and/or a random access memory. Generally, a computer includes one or more mass storage devices for storing data files. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). Further, a computer data signal representing the software code which may be embedded in a carrier wave may be transmitted via a communication network. Such a computer readable memory and a computer data signal are also within the scope of the present invention, as well as the hardware, software and the combination thereof.

The present invention has been described with regard to one or more embodiments. However, it should be apparent to persons skilled in the art that a number of variations and modifications can be made without departing from the scope of the invention as defined in the claims.

What is claimed is:

1. A method of scheduling a professional service using artificial intelligence, the method comprising the steps of:
storing historical data;
training a neural network using the historical data to learn a schedule allocation;
receiving a current request for the professional service;
generating one or more than one input signals based on the current request;
applying the input signals to the neural network having the learned schedule allocation;
reserving an appointment in a schedule; and
outputting the appointment.

2. The method according to claim 1, wherein the training step comprises generating a plurality of weights for the neural network from the historical data.

3. The method according to claim 1, wherein the input signal comprises a lead-lag indicator, the lead-lag indicator derived from the real time of the professional service, and completed tasks in the schedule.

4. The method according to claim 1, wherein the professional service is a medical service.

5. The method according to claim 1, wherein the professional service is a service requiring a plurality of resources.

6. The method according to claim 1, wherein the professional service is a service provided by a plurality of professionals.

7. The method according to claim 1, wherein the input signal comprises a type of medical visit.

8. The method according to claim 1, wherein the current request is for rescheduling an existing appointment.

9. The method according to claim 1, wherein the appointment is a blocked time.

10. The method according to claim 1, wherein the input signal comprises average time needed by a professional to complete a type of the appointment.

11. The method according to claim 1, wherein the input signal comprises average appointment time needed for a person receiving the professional service.

12. The method according to claim 1, wherein the input signal comprises scheduled appointment time.

13. The method according to claim 1, wherein the input signal comprises next appointment time.

14. The method according to claim 1, wherein the appointment is a planed periods of multiple appointments to a single start time.

15. The method according to claim 1, wherein appointments of same type is grouped together.

16. An apparatus for scheduling a professional service using artificial intelligence, the apparatus comprising:
a memory for storing historical data;
a neural network having a plurality of nodes, each node connected to one or more than one neighboring nodes, said neural network trained by the historical data to modify the weights, said neural network being responsive to a plurality of input signals, including one or more than one input signals generated from a current request for the professional service; said neural network generates an appointment in a schedule; and
means for displaying the schedule.

17. The apparatus according to claim 16, wherein a background discontinuity is displayed in the schedule, said background discontinuity indicating the real time of the apparatus.

18. The apparatus according to claim 16, wherein the professional service is a medical service.

19. The apparatus according to claim 16, wherein the professional service is a service provided by a plurality of professionals.

20. The apparatus according to claim 16, wherein the current request is for rescheduling an existing appointment.

21. The apparatus according to claim 16, wherein the input signal comprises average time needed by a professional to complete a type of the appointment.

22. The apparatus according to claim 16, wherein the input signal comprises average appointment time needed for a person receiving the professional service.

23. The apparatus according to claim 16, wherein the input signal comprises scheduled appointment time.

24. A computer readable medium storing instructions or statements for use in the execution in a computer of a method of scheduling a professional service using artificial intelligence, the method comprising the steps of:
storing historical data;
training a neural network using the historical data to learn a schedule allocation;
receiving a current request for the professional service;
generating one or more than one input signals based on the current request;
applying the input signals to the neural network having the learned schedule allocation;
reserving an appointment in a schedule; and
outputting the appointment.

25. The computer readable medium according to claim 24, wherein the training step comprises generating a plurality of weights for the neural network from the historical data.

26. The computer readable medium according to claim 24, wherein the input signal comprises a lead-lag indicator, the lead-lag indicator derived from the real time of the professional service, and completed tasks in the schedule.

27. The computer readable medium according to claim 24, wherein the professional service is a medical service.

28. The computer readable medium according to claim 24, wherein the professional service is a service provided by a plurality of professionals.

29. The computer readable medium according to claim 24, wherein the current request is for rescheduling an existing appointment.

30. The computer readable medium according to claim 24, wherein the appointment is a blocked time.

31. The computer readable medium according to claim 24, wherein the input signal comprises average time needed by a professional to complete a type of the appointment.

32. The computer readable medium according to claim 24, wherein the input signal comprises average appointment time needed for a person receiving the professional service.

33. The computer readable medium according to claim 24, wherein the input signal comprises scheduled appointment time.

34. A computer program product comprising:
a memory having microcontroller-readable code embedded therein for scheduling a professional service using artificial intelligence, comprising:
code means training a neural network using the historical data to learn a schedule allocation;
code means for receiving a current request for the professional service;
code means for generating one or more than one input signals based on the current request;
code means for applying the input signals to the neural network having the learned schedule allocation;
code means for generating an appointment in a schedule; and
code means for outputting the appointment.
